(19) United States
(12) Patent Application Publication
(10) Pub. No.: US 2025/0080275 A1
(43) Pub. Date: Mar. 6, 2025

(54) ENHANCEMENTS TO REQUEST TO SEND AND CLEAR TO SEND EXCHANGES

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Gaurang NAIK, San Diego, CA (US); Abdel Karim AJAMI, San Diego, CA (US); Yanjun SUN, San Diego, CA (US); Sai Yiu Duncan HO, San Diego, CA (US)

(21) Appl. No.: 18/458,746

(22) Filed: Aug. 30, 2023

(51) Int. Cl. H04L 1/00; H04L 1/06

(52) U.S. Cl. CPC H04L 1/0069; H04L 1/0027; H04L 1/06

(57) ABSTRACT

This disclosure provides methods, components, devices and systems for enhancements to request to send (RTS) and clear to send (CTS) exchanges. A first wireless device may receive a beacon frame indicating for the first wireless device to monitor a first channel for a first frame that schedules communication via one or more channels. The first wireless device may receive, from a second wireless device, the first frame indicating a channel bandwidth and a puncturing pattern of multiple available puncturing patterns for the channel bandwidth. The puncturing pattern may be associated with a first subset of a set of multiple channels of the channel bandwidth. The first wireless device may transmit, to the second wireless device, a second frame indicating that a second subset of channels is available and may receive one or more data packets via the second subset of channels.

### TECHNICAL FIELD

This disclosure relates to wireless communication and, more specifically, to enhancements to request to send (RTS) and clear to send (CTS) exchanges.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a first wireless device (such as an STA or an AP) and a second wireless device (such as an STA or an AP) may exchange a request to send (RTS) frame and a clear to send (CTS) frame. The RTS frame and the CTS frame may be frames carried within a physical layer (PHY) protocol data unit (PPDU). For example, a physical layer convergence procedure (PLCP) service data unit (PSDU) of the PPDU may include the RTS frame or the CTS frame. The RTS frame or the CTS frame may include bandwidth information associated with communication (such as exchange of data) between the first wireless device and the second wireless device.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless device. The method may include receiving a beacon frame indicating for the first wireless device to monitor a first channel for a first frame that schedules communication via one or more channels, receiving, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, transmitting, to the second wireless device, at least one second frame indicating that a second subset of the set of multiple channels is available, the second subset being at least a subset of the first subset, and receiving, from the second wireless device, one or more data packets via the second subset of the set of multiple channels based on the at least one second frame.

Another innovative aspect of the subject matter described in this disclosure can be implemented in a first wireless device. The first wireless device may include a processing system that includes processor circuitry and memory circuitry that stores code. The processing system may be configured to cause the first wireless device to receive a beacon frame indicating for the first wireless device to monitor a first channel for a first frame that schedules communication via one or more channels, receive, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, transmit, to the second wireless device, at least one second frame indicating that a second subset of the set of multiple channels is available, the second subset being at least a subset of the first subset, and receive, from the second wireless device, one or more data packets via the second subset of the set of multiple channels based on the at least one second frame.

Another innovative aspect of the subject matter described in this disclosure can be implemented in a first wireless device. The first wireless device may include means for receiving a beacon frame indicating for the first wireless device to monitor a first channel for a first frame that schedules communication via one or more channels, means for receiving, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, means for transmitting, to the second wireless device, at least one second frame indicating that a second subset of the set of multiple channels is available, the second subset being at least a subset of the first subset, and means for receiving, from the second wireless device, one or more data packets via the second subset of the set of multiple channels based on the at least one second frame.

Another innovative aspect of the subject matter described in this disclosure can be implemented in a non-transitory computer-readable medium storing code. The code may include instructions executable by one or more processors to receive a beacon frame indicating for the first wireless device to monitor a first channel for a first frame that schedules communication via one or more channels, receive, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, transmit, to the second wireless device, at least one second frame indicating that a second subset of the set of multiple channels is available, the second subset being at least a subset of the first subset, and receive, from the second wireless device, one or more data packets via the second subset of the set of multiple channels based on the at least one second frame.

In some examples of the method, first wireless devices, and non-transitory computer-readable medium described herein, the first channel may be associated with a second channel bandwidth that may be smaller than the channel bandwidth.

Some examples of the method, first wireless devices, and non-transitory computer-readable medium described herein may further include operations, features, means, or instructions for monitoring the first channel for the first frame based on the beacon frame and monitoring the second subset of the set of multiple channels for the one or more data packets based on the at least one second frame.

In some examples of the method, first wireless devices, and non-transitory computer-readable medium described herein, the beacon frame indicates a second channel within the channel bandwidth to monitor for the first frame.

In some examples of the method, first wireless devices, and non-transitory computer-readable medium described herein, the first frame indicates a first number of spatial streams (NSS) associated with wireless communication with the second wireless device.

In some examples of the method, first wireless devices, and non-transitory computer-readable medium described herein, the at least one second frame indicates that a second NSS may be available and the one or more data packets may be received via the second NSS.

In some examples of the method, first wireless devices, and non-transitory computer-readable medium described herein, the puncturing pattern indicates that the first channel may be punctured.

Some examples of the method, first wireless devices, and non-transitory computer-readable medium described herein may further include operations, features, means, or instructions for performing a clear channel assessment (CCA) of each channel of the set of multiple channels based on the first frame, where the second subset of the set of multiple channels may be based on the CCA.

Another innovative aspect of the subject matter described in this disclosure can be implemented in a method for wireless communications by a first wireless device. The method may include transmitting a beacon frame indicating for a second wireless device to monitor a first channel for a first frame that schedules communication via one or more channels, transmitting, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, receiving, from the second wireless device, at least one second frame indicating that a second subset of the set of multiple channels is available, the second subset being at least a subset of the first subset, and transmitting, to the second wireless device, one or more data packets via the second subset of the set of multiple channels based on the at least one second frame.

Another innovative aspect of the subject matter described in this disclosure can be implemented in a first wireless device. The first wireless device may include a processing system that includes processor circuitry and memory circuitry that stores code. The processing system may be configured to cause the first wireless device to transmit a beacon frame indicating for a second wireless device to monitor a first channel for a first frame that schedules communication via one or more channels, transmit, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, receive, from the second wireless device, at least one second frame indicating that a second subset of the set of multiple channels is available, the second subset being at least a subset of the first subset, and transmit, to the second wireless device, one or more data packets via the second subset of the set of multiple channels based on the at least one second frame.

Another innovative aspect of the subject matter described in this disclosure can be implemented in a first wireless device. The first wireless device may include means for transmitting a beacon frame indicating for a second wireless device to monitor a first channel for a first frame that schedules communication via one or more channels, means for transmitting, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, means for receiving, from the second wireless device, at least one second frame indicating that a second subset of the set of multiple channels is available, the second subset being at least a subset of the first subset, and means for transmitting, to the second wireless device, one or more data packets via the second subset of the set of multiple channels based on the at least one second frame.

Another innovative aspect of the subject matter described in this disclosure can be implemented in a non-transitory computer-readable medium storing code. The code may include instructions executable by one or more processors to transmit a beacon frame indicating for a second wireless device to monitor a first channel for a first frame that schedules communication via one or more channels, transmit, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth, receive, from the second wireless device, at least one second frame indicating that a second subset of the set of multiple channels is available, the second subset being at least a subset of the first subset, and transmit, to the second wireless device, one or more data packets via the second subset of the set of multiple channels based on the at least one second frame.

In some examples of the method, first wireless devices, and non-transitory computer-readable medium described herein, the first channel may be associated with a second channel bandwidth that may be smaller than the channel bandwidth.

In some examples of the method, first wireless devices, and non-transitory computer-readable medium described herein, the beacon frame indicates a second channel within the channel bandwidth to monitor for the first frame.

In some examples of the method, first wireless devices, and non-transitory computer-readable medium described herein, the first frame indicates a first NSS associated with wireless communication with the second wireless device.

In some examples of the method, first wireless devices, and non-transitory computer-readable medium described herein, the at least one second frame indicates that a second NSS may be available and the one or more data packets may be transmitted via the second NSS.

In some examples of the method, first wireless devices, and non-transitory computer-readable medium described herein, the puncturing pattern indicates that the first channel may be punctured.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIGS. 5-8 show examples of signaling diagrams that support enhancements to request to send (RTS) and clear to send (CTS) exchanges.

FIGS. 9A and 9B show an example of an RTS frame and a CTS frame that support enhancements to RTS and CTS exchanges.

FIG. 10 shows an example of a process flow that supports enhancements to RTS and CTS exchanges.

FIG. 11 shows a block diagram of an example wireless communication device that supports enhancements to RTS and CTS exchanges.

FIGS. 12-14 show flowcharts illustrating example processes performable by or at a first wireless device that supports enhancements to RTS and CTS exchanges.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In some WLANs, wireless devices, such as wireless stations (STAs) or wireless access points (APs), may perform an exchange of request to send (RTS) and clear to send (CTS) frames. The RTS and CTS frames may establish a bandwidth for wireless communication during a transmission opportunity (TXOP) between the wireless devices. For example, a first wireless device may transmit an RTS frame to a second wireless device indicating a first bandwidth. In some cases (such as static bandwidth negotiation), the second wireless device may transmit a CTS frame only if the full first bandwidth is available at the second wireless device. In other cases (such as dynamic bandwidth negotiation), the second wireless device may transmit the CTS frame if a primary channel of the first bandwidth is available, and the CTS frame may indicate a second bandwidth that is smaller than the first bandwidth (such as to indicate that secondary channels of the first bandwidth are busy). In such cases, the second wireless device may perform a clear channel assessment (CCA) of each channel within a bandwidth that the second wireless device supports prior to receiving the RTS frame (such as during a point coordination function inter-frame space (PIFS)). In some examples, an ultra-high reliability (UHR) wireless device may support a relatively large bandwidth (such as 480 MHz, 640 MHZ) relative to bandwidths associated with RTS or CTS frames. Moreover, for a UHR wireless device that supports the larger bandwidth, performing a CCA of all channels within the large bandwidth prior to receiving the RTS frame may use a large amount of processing resources. Thus, enhancements to RTS or CTS signaling may be beneficial to support greater flexibility, reduced power consumption, and increased throughput for wireless communications over large bandwidths.

In some implementations of the present disclosure, wireless devices that exchange RTS or CTS frames may support a bandwidth extension of the RTS or CTS frames or dynamic puncturing of the RTS or CTS frames. For example, a first wireless device may transmit an RTS frame to a second wireless device that includes a channel bandwidth and a puncturing pattern for the channel bandwidth. The puncturing pattern may indicate a first subset of channels of the channel bandwidth that is available at the first wireless device. The second wireless device may transmit a CTS frame to the first wireless device, and the CTS frame may indicate a second subset of channels of the channel bandwidth that is available at the second wireless device. The second subset of channel may be the same as the first subset of the channels (such as to confirm the RTS frame) or may be different from the second subset of channels (such as to override the RTS frame). The first wireless device may transmit data (such as one or more data packets) to the second wireless device via the second subset of channels based on the CTS frame.

By dynamically puncturing channels of the channel bandwidth using RTS or CTS frames, the described techniques may support reduced interference of wireless communications and efficient resource utilization. For example, by indicating a first subset of channels of the channel bandwidth in an RTS frame, the first wireless device may enable communication over any channels of the channel bandwidth that are available, thereby increasing resource utilization, while also reducing interference or loss of data associated with other channels of the channel bandwidth that may be busy. Moreover, by enabling a second wireless device to indicate a second subset of channels of the channel bandwidth in a CTS frame, the described techniques may support increased flexibility and more efficient utilization of resources of the channel bandwidth. For example, in cases where one or more of the first subset of channels may be unavailable at the second wireless device, the second wireless device may indicate a portion of the first subset of channels that is available at the second device. Thus, rather than waiting for the first subset of channels to become available at the second wireless device or otherwise delaying communications, the first wireless device may transmit data to the second wireless device via the second subset of channels, which may support reduced power consumption, reduced latency, and increased spectral efficiency.

In some examples, a receiving wireless device that receives an RTS frame may perform a CCA after the receiving wireless device receives the RTS frame, and the CCA may be used for determining whether each channel that is indicated by the RTS frame is available or busy. For example, the receiving wireless device may perform the CCA during a short inter-frame space (SIFS) between receiving the RTS frame and sending the CTS frame as opposed to during PIFS before receiving the RTS frame. By performing the CCA during SIFS as opposed to PIFS, the receiving wireless device may support indication of a more accurate and updated CCA status of channels associated with the RTS frame. Moreover, the receiving wireless device may, prior to receiving the RTS frame, monitor one or more primary channels rather than monitoring a larger channel bandwidth that the receiving device supports, which may support reduced power consumption and reduced processing at the receiving wireless device. In some implementations, the RTS/CTS exchange may support non-primary channel access. For example, the receiving wireless device may receive the RTS frame or may transmit the CTS frame over one or more non-primary channels, which may support efficient utilization of resources by utilizing resources that may otherwise go unused, thereby increasing spectral efficiency. In some aspects of the present disclosure, exchanges of RTS and CTS frames may support dynamic indication of a number of spatial streams (NSS) for communication. As such, the described techniques may enable a wireless device to dynamically indicate that some spatial streams are available (and that other spatial streams are reserved for other communication protocols), which may support reduced power consumption, more efficient allocation of communication resources, and increased throughput.

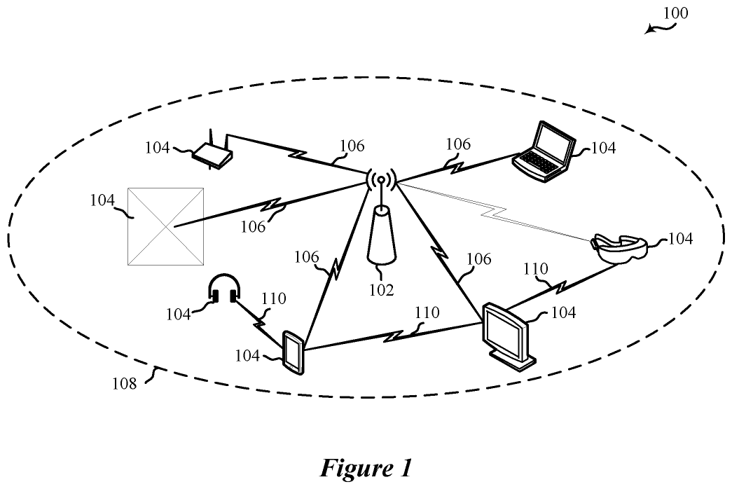

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHZ-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHZ bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHZ. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as CCA operation based on EHT enhancements such as increased bandwidth, puncturing, or refinements to carrier sensing and signal reporting mechanisms.

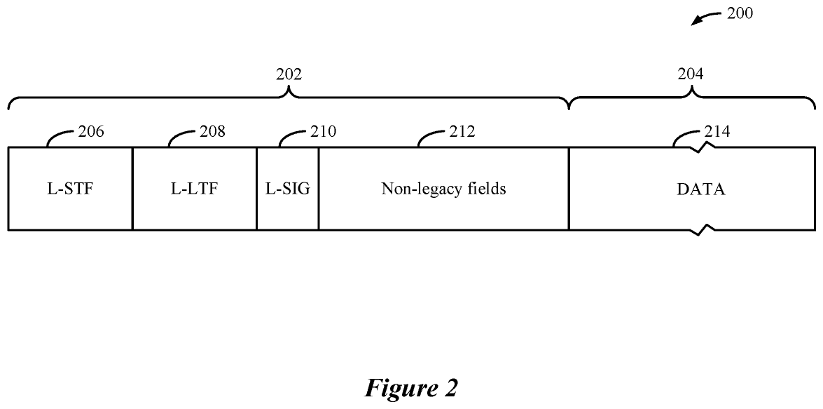

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

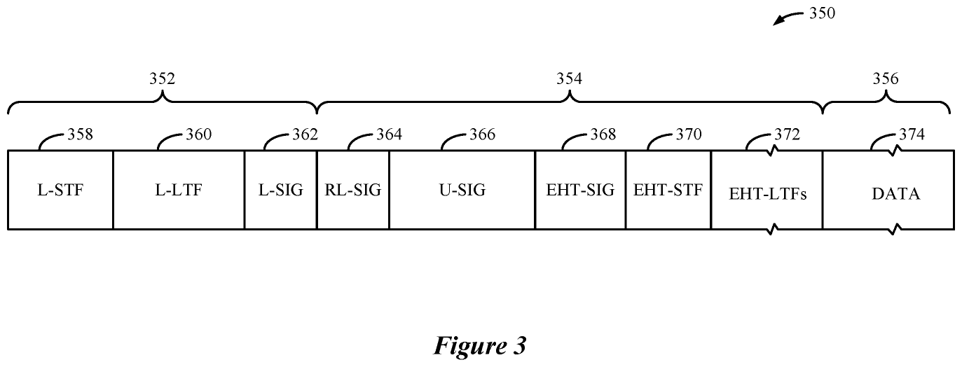

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

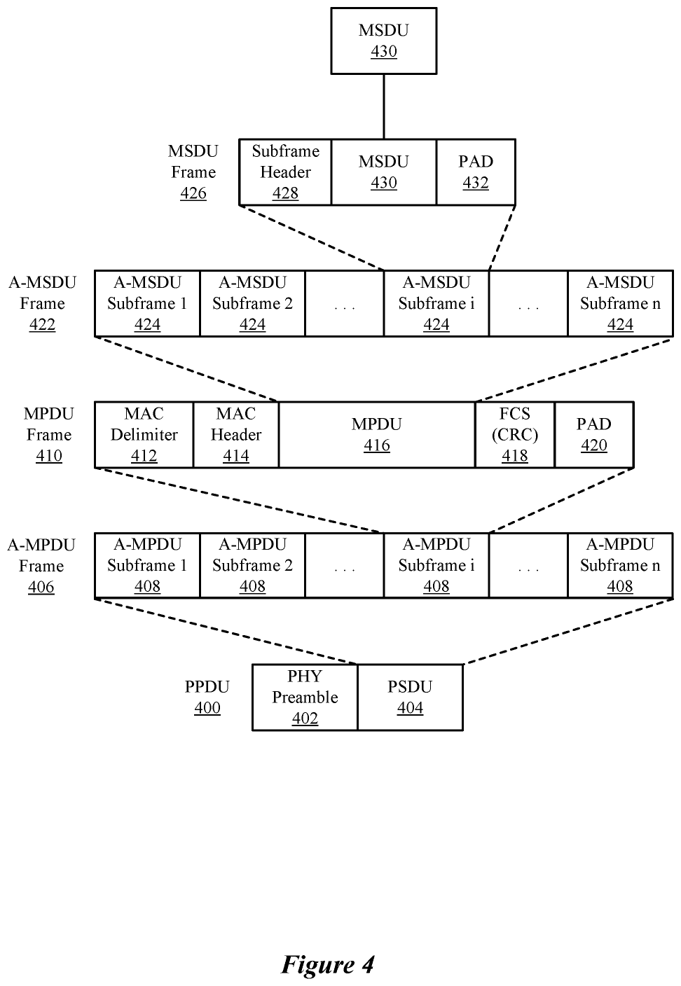

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field may include a cyclic redundancy check (CRC)) and padding bits 420. The MPDU 416 may carry one or more MAC service data units (MSDUs) 416. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the SIFS, the PIFS, the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a CCA and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a NAV, which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of WLAN 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as either an AP 102 or a STA 104) or a receiving device (such as either an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are then mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, power level, etc. to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased NSS (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUS) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHZ and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

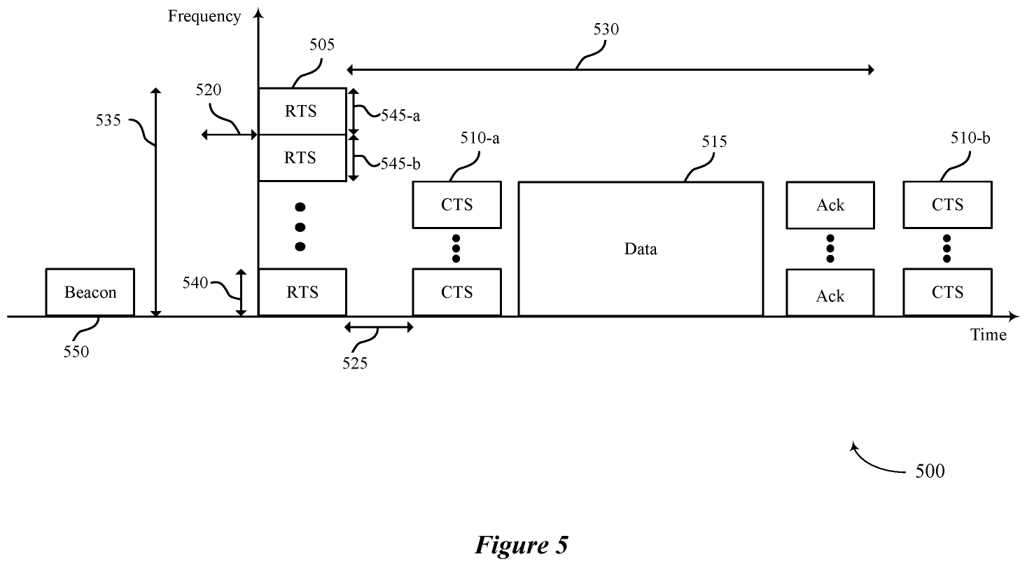

FIG. 5 shows an example of a signaling diagram 500 that supports enhancements to RTS and CTS exchanges. The signaling diagram 500 may implement aspects of the wireless communication network 100, the PDU 200, the PDU 350, and the PPDU 400. For example, the signaling diagram 500 may include an RTS frame 505 and a CTS frame 510, which may be examples of frames to be included in a PSDU 404 of a PPDU 400, as described with reference to FIG. 4.

Wireless devices, such as STAs or APs, may communicate over a primary channel 540 (such as a primary 20 MHz channel). In some examples (such as for downlink RTS), a first wireless device (such as an AP or an STA) may transmit a beacon frame 550 to a second wireless device (such as an STA), and the beacon frame 550 may establish the primary channel 540 for a channel bandwidth 535. The beacon frame 550 may indicate for the second wireless device to monitor the primary channel 540 for a first frame (such as the RTS frame 505). In some examples, the beacon frame 550 may explicitly indicate the primary channel 540. In some other examples, the second wireless device may receive the beacon frame 550 via the primary channel 540 and may determine that the primary channel 540 is a primary channel of communication or may determine to monitor the primary channel 540 for the first frame based on receiving the beacon frame 550 via the primary channel 540. In cases of uplink RTS, the first wireless device may determine that the second wireless device is on the primary channel 540 and may predict to receive the first frame (such as the RTS frame 505) via the primary channel 540. The first wireless device may receive the first frame from the second wireless device via the primary channel 540. The RTS frame 505 may schedule communication via one or more channels. For example, the RTS frame 505 may schedule communication via the primary channel 540, via a secondary channel 545-a, via a secondary channel 545-b, or via other channels of the channel bandwidth 535.

An STA that receives the RTS frame 505 may check the CCA status of each secondary channel 545, during a PIFS 520, prior to the start of transmission of the RTS frame 505. To check the CCA status, the STA may establish an active CCA (such as may perform CCA of each channel) in the channel bandwidth 535 in listen mode or receive (Rx) mode. The channel bandwidth 535 may correspond to a full Rx bandwidth associated with the STA. Accordingly, the STA may operate (such as may activate antennas) over the full channel bandwidth 535 prior to receiving the RTS frame 505 (such as for most of the time that the STA is awake), which may result in large power consumption relative to the STA operating over the primary channel 540. In some examples, by performing the CCA during the PIFS 520, the STA may provide an out-of-date CCA status. For example, a channel status of each channel of the channel bandwidth 535 during the PIFS 520 prior to the RTS frame 505 may be different with respect to a channel status of each channel during a SIFS 525 after the RTS frame 505.

In some examples, the STA (such as a UHR STA) may perform a CCA to check the status of each secondary channel 545, during the SIFS 525, after the end of (such as upon completion of) the RTS frame 505 addressed to the STA. By performing the CCA during the SIFS 525, the STA may provide an up-to-date CCA status to a TXOP holder that transmits the RTS frame 505. For example, the CCA status may be more accurate or more up-to-date relative to a CCA status of the secondary channels 545 during the PIFS 520. The STA may perform similar CCA status checks during the SIFS 525 in cases where the STA receives an MU RTS trigger frame. The STA may monitor only the one or more primary channel 540 in listen mode prior to receiving the RTS frame 505. For example, during the PIFS 520, or during any other time prior to receiving the RTS frame 505, the STA may monitor the one or more primary channel 540 and refrain from monitoring secondary channels 545 of the channel bandwidth 535, which may reduce power consumption and increase battery life.

Upon reception of the RTS frame 505, which the STA may receive via the primary channel 540, the STA may expand an RF front end (RFE) of the STA up to the channel bandwidth 535. The channel bandwidth 535 may be associated with the RTS frame 505, and in some implementations, the RTS frame 505 may indicate the channel bandwidth 535. The STA may begin expansion of the RFE upon verification that a receiver address (RA) of the RTS frame 505 includes a MAC address of the STA. Additionally, or alternatively, the STA may begin expansion of the RFE upon determination that an L-SIG length field of the RTS frame 505 is 20 octets, which may correspond to a length associated with an RTS frame. The RFE expansion may complete SIFS—aCCATime after the RTS frame, where aCCATime is a time associated with the STA performing CCA (such as energy detect (ED) CCA) in the secondary channels 545.

In some examples, the STA may transmit the CTS frame 510-a after the SIFS 525. The CTS frame 510-a may be in response to the RTS frame 505, and the STA may transmit the CTS frame 510-a within zero or more channels indicated in the RTS frame that is idle (e.g., some or all of the bandwidth indicated in the RTS frame that is idle and thus available for transmission). The STA may determine the idle bandwidth based on performing the CCA (such as one or more channel measurements) within the SIFS 525 for each channel indicated in the RTS frame. The STA may transmit the CTS frame 510-a indicating that a bandwidth is available that is the same size as, or smaller than, the bandwidth 535 associated with the RTS frame 505. For example, the CCA may indicate that zero or more of the secondary channels, such as secondary channel 545-a and secondary channel 545-b, may be busy (such as unavailable) at the STA or the STA may be operating in a reduced bandwidth mode. That is, the CTS frame 510-a may indicate that at least a subset of channels requested in the one or more RTS frames 505 is available at the STA, and the subset of channels may be at least a subset of the channel bandwidth 535 requested in the RTS frame 505. Based on the CTS frame 510-a, the STA may receive data 515 (such as one or more data packets) from another wireless device (such as an AP, a peer STA) via the subset of channels that the STA indicates are available in the CTS frame 510-a.

The RTS frame 505 may indicate a time duration, such as a NAV 530. The NAV 530 may begin after receipt of the RTS frame 505. The NAV 530 may indicate to other wireless devices a time duration during which a wireless communication session (such as a TXOP) is taking place between a transmitting wireless device indicated by the RTS frame and a receiving wireless device indicated by the RTS frame 505. Thus, the NAV 530 may indicate that one or more channels of the channel bandwidth 535 are busy, and the other wireless devices may refrain from transmitting on the one or more channels during the time duration. In some examples, the receiving wireless device (such as an STA) may dynamically expand or reduce a duration of the NAV 530 via the CTS frame 510-a. In some examples, the CTS frame 510-a may indicate a time duration that is longer than a time duration indicated in the soliciting RTS frame. The indication of the longer duration may be subject to (such as may not exceed) a TXOP limit. In such examples, the transmitting wireless device and the receiving wireless device may use the duration (such as a remainder of the TXOP) for low latency exchanges, relay operations, or other signaling. In some other examples, the CTS frame 510-a may indicate a time duration that is shorter than a time duration indicated in the soliciting RTS frame, which may be beneficial in examples of coexistence (such as STA is unavailable after X ms, where the RTS may indicate a NAV having a time duration of Y ms, where X<Y)), an upcoming quiet time of the receiving wireless device, or a restricted-target wake time (R-TWT) service period (SP) of the receiving wireless device, among other examples.

In some examples, the transmitting wireless device may use the RTS frame 505 to probe an availability of an STA. One or more wireless devices, including the STA, may receive the RTS frame 505 and may ignore the NAV 530 indicated in the RTS frame 505, or may disregard the NAV 530 indicated in the RTS frame 505 with respect to determining an availability of the channel bandwidth 535 associated with the RTS frame 505. The RTS frame 505 may not schedule any communication (such as any transmission of data 515). Rather, the RTS frame 505 may probe the availability of the STA, and the STA may transmit the CTS frame 510-a, an ACK, or some other frame, including an indication that the STA is available for wireless communication via the channel bandwidth 535. In some examples, the RTS frame 505 may include a bit that indicates to ignore the NAV 530 or indicates that the RTS frame 505 is probing the availability of the STA, and thus that the channel is otherwise not being reserved for transmission. Additionally, or alternatively, the RTS frame may indicate to ignore the NAV 530 or indicate that the RTS frame 505 is probing STA availability based on a duration value of the RTS frame 505 (such as the NAV 530), or a duration of the TXOP, satisfying a threshold or other condition.

Using the RTS frame 505 to probe STA availability may enable low latency data delivery that is not impacted by basic NAV settings. For example, by performing probing of STA availability using the RTS frame 505, wireless devices may satisfy an RTS/CTS exchange condition (such as an RTS/CTS requirement or prerequisite) that enables data/ACK exchanges, and the wireless devices may perform data/ACK exchanges to equalize a field associated with wireless communication. In some examples, the transmitting wireless device may utilize a QoS Null/ACK exchange or a Data/ACK exchange to probe STA availability. In such examples, the transmitting wireless device may have a non-HT duplicate mode.

In some implementations, the receiving wireless device (such as an STA) may transmit a CTS frame 510-b that is delayed. For example, the STA may transmit the CTS frame 510-b after expiration of the NAV 530 indicated in an RTS frame. In some examples, in place of the CTS frame 510-b, the STA may transmit a trigger frame, which may enable the transmitting wireless device to transmit the data 515 (such as uplink data). In some examples, the STA may indicate to the transmitting wireless device when the NAV 530 (such as a basic NAC) is expected to expire. For example, the STA may transmit the CTS frame 510-b upon expiration of the NAV 530 or at a threshold duration prior to expiration of the NAV 530.

In some examples, techniques described herein may be implemented to enhance the RTS frame 505 and the CTS frame 510. In some other examples, similar enhancements described herein may be applied to other frames, such as control frames, management frames, or data frames. For example, a first frame, which may be described herein with reference to the RTS frame 505, may alternatively be an MU RTS frame, and a second frame, which may be described herein with reference to the CTS frame 510, may be a CTS frame. The MU RTS frame and the CTS frame may be examples of control frames. In some examples, the first frame may be a buffer status report poll (BSRP) trigger frame, and the second frame may be a QoS Null frame that carries a buffer status report (BSR). The BSRP trigger frame may be an example of a control frame and a BSR frame may be an example of a data frame. In some other examples, the first frame may be a beamforming report poll (BFRP) frame, and the second frame may be a compressed beamforming report (BFR) frame or a channel quality indicator (CQI) frame. The BFRP frame may be an example of a control frame, and the compressed BFR frame or the CQI frame may be examples of an action frame, which may be a subtype of a management frame.

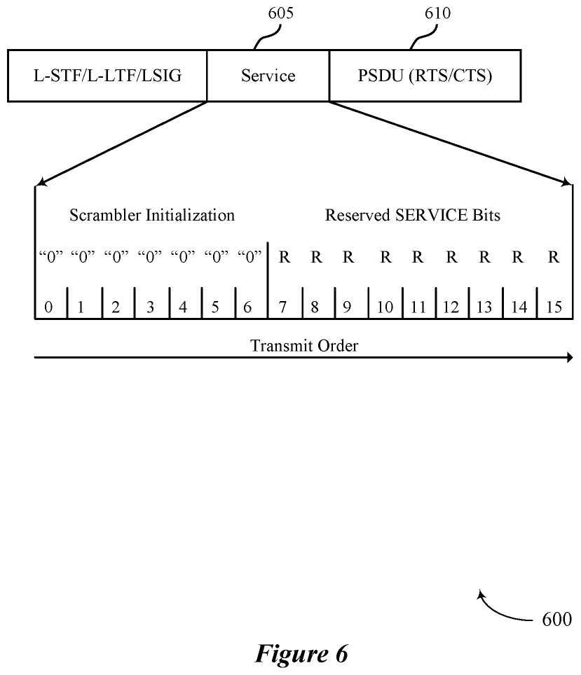

FIG. 6 shows an example of a signaling diagram 600 that supports enhancements to RTS and CTS exchanges. The signaling diagram 600 may implement aspects of the wireless communication network 100, the PDU 200, the PDU 350, and the PPDU 400. For example, the signaling diagram 600 may include a service field 605 and a PSDU field 610, which may be examples of fields to be included in a PPDU 300 or a PPDU 400, as described with reference to FIGS. 3 and 4, respectively.

A transmitting wireless device (such as an STA, an AP) may transmit a PPDU to a receiving wireless device (such as an STA) and the PPDU may include a service field 605 and a PSDU field 610. The PSDU field may include an RTS frame (such as the RTS frame 505 as described with reference to FIG. 5). The transmitting wireless device may use the service field 605 to indicate a bandwidth extension, dynamic puncturing, non-primary channel access, or a combination thereof. For example, the transmitting wireless device may expand signaling in the service field 605 of the PPDU (such as a non-HT (duplicate) PPDU) that carries control frames, such as RTS or CTS frames. Accordingly, the service field 605 may indicate a bandwidth extension, dynamic puncturing, or non-primary channel access to apply to RTS/CTS frames to enable TXOP protection for wider Bandwidths and dynamically punctured frame exchanges.

An EHT STA may support bandwidths up to 40 MHz in 2.4 GHz wireless networks, 160 MHz in 5 GHz wireless networks, and 320 MHz in 6 GHz wireless networks. A UHR STA may support larger bandwidths relative to those that the EHT STA supports. For example, the UHR STA may support bandwidths up to 480 MHz or up to 640 MHz (such as in 6 GHz wireless networks). Thus, it may be beneficial to enable up to 640 MHz bandwidth signaling for exchange of RTS and CTS frames, and a transmitting device or a receiving device may use the service field 605 of the PPDU to indicate a channel bandwidth that the respective device supports. As shown in Table 1, bits B5-B7 of the service field 605 may indicate a bandwidth (such as a bandwidth between 20 MHz and 640 MHz) for communication between the transmitting wireless device and a receiving wireless device.

TABLE 1

| Service field | | | | | | Possible |
|---|---|---|---|---|---|---|
| [B6-65] | [B4]DYN | [B7] | BW | | Generation | Patterns |
| 0 | Any | 0 | 20 | MHz | Any (VHT, | None |
| 1 | Any | 0 | 40 | MHz | HE, EHT, | 1 |
| 2 | Any | 0 | 80 | MHz | UHR) | 10 |
| 3 | Any | 0 | 160 MHz/80 + | | | 245 |
| | | | 80 MHz | | | |
| 0 | Any | 1 | 320 | MHz | EHT | . . . |
| 1 | Any | 1 | 480 MHz - 320-1 | | UHR | . . . |
| | | | 480 MHz - 320-2 | | | |
| 2 | Any | 1 | 640 | MHz | | . . . |

| | | | | |
|---|---|---|---|---|
| 3 | Any | 1 | Reserved | . . . |

Accordingly, the transmitting wireless device may transmit an RTS frame that indicates a channel bandwidth, and the receiving device may transmit a CTS frame that indicates a second channel bandwidth that confirms the channel bandwidth or indicates a different channel bandwidth. In some examples, a 480 MHz bandwidth may be associated with two candidate 320 MHz bandwidths (such as 320-1 or 320-2). The transmitting wireless device may indicate which 320 MHz bandwidth to use (e.g., lower 320 MHz of the 480 MHz or upper 320 MHz of the 480 MHz) in implementations where the transmitting wireless device indicates the 480 MHz bandwidth. By using the service field 605 to indicate the bandwidth (such as a bandwidth extension relative to a 20 MHz channel), the described techniques may support backwards compatibility for control frames in a non-HT (duplicate) PPDU format such that the PPDU may support UHR STAs and non-UHR STAs. In some examples, the transmitting wireless device may indicate a 640 MHz bandwidth using a combination of smaller values (such as by indicating 240 MHz and 400 MHZ). The indication of bandwidths of 480 MHz or 640 MHz may be used in 6 GHz wireless networks.

In some examples, the transmitting wireless device or the receiving wireless device may indicate a puncturing pattern to indicate that a subset of channels of the channel bandwidth (such as a bandwidth indicated by the service field 605) are available at the respective wireless device. For example, the puncturing pattern may puncture (such as disable, turn off) channels of the channel bandwidth that are busy. Any of the reserved SERVICE bits of the service field 605 may be used to indicate the puncturing pattern. For example, Bits B8-B10 of the service field may indicate up to seven puncturing patterns. Accordingly, the transmitting wireless device may transmit an RTS frame that indicates one of the puncturing patterns, and the receiving device may transmit a CTS frame that indicates a second puncturing pattern that confirms the pattern indicated in the RTS frame or indicates a different puncturing pattern. More bits of the service field may be used to indicate the puncturing patterns (e.g., additional bits may be used to support a larger quantity of patterns, such as 36, 48, 64, etc., patterns). The indication of a puncturing pattern using the service field 605 may be used in 6 GHZ wireless networks.

In some examples, a primary channel (such as the primary channel 540 as described with reference to FIG. 5) may be busy, and the RTS/CTS frame exchange may occur over non-primary channels. In such examples, the transmitting wireless device or the receiving wireless device may indicate a location of a temporary primary channel. For example, the transmitting wireless device may designate a secondary channel (e.g., channel 545-b in FIG. 5) as the temporary primary channel. The transmitting wireless device or the receiving wireless device may use bits of the service field 605 (such as similar to indication of the puncturing pattern) to indicate the location of the temporary primary channel. In some examples, the puncturing pattern may indicate that the primary channel is busy or may indicate the location of the temporary primary channel. In some other examples, a beacon frame or a probe/association response frame may indicate the location of the temporary primary channel prior to the RTS frame. In such examples, the transmitting wireless device may transmit the RTS frame to the receiving wireless device via the temporary primary channel, and the RTS frame may indicate the puncturing pattern with respect to the temporary primary channel. In some examples, for either or both of preamble puncturing or non-primary channel access, a receiver STA may be in 20-MHz listening mode, and the primary channel may be part of a non-HT (duplicate) RTS transmission.

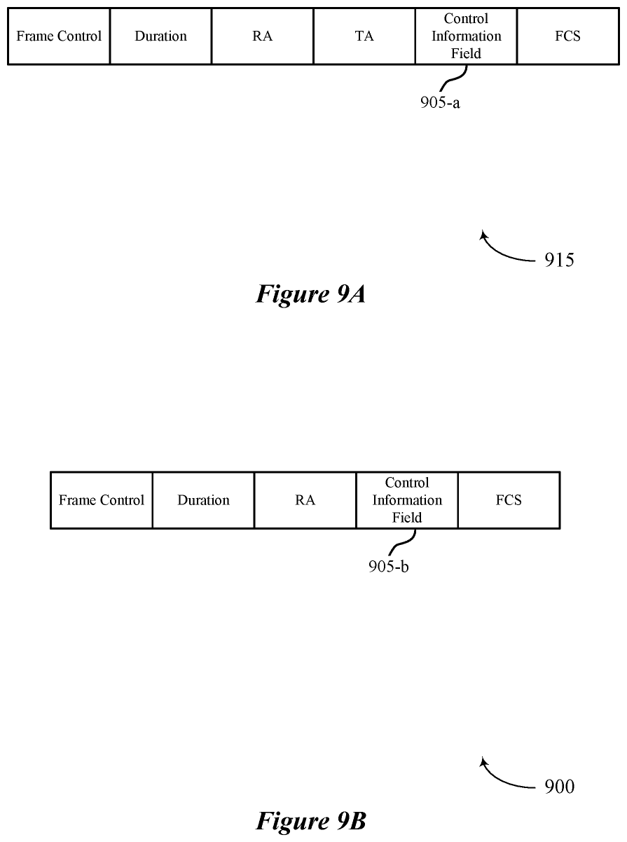

In some examples (such as in implementations in 5 GHz band), a wireless device may not overload the service field 605 to avoid misinterpretation of the service field 605 (such as by non-UHR STAs). In such examples, the wireless device may include an aggregated control (A-control) field in the RTS or CTS frame, as described in greater detail with reference to FIGS. 9A and 9B, to indicate the bandwidth, puncturing pattern, or the location of the temporary primary channel. Additionally, or alternatively, the wireless device may use an MU RTS trigger frame to indicate such information. In such implementations, a response CTS frame may have added flexibility. For example, the CTS frame may untie a Scrambler value to the Scrambler value of the MU RTS trigger frame (such as in implementations where the MU RTS trigger frame is individually addressed). In some other implementations, the receiving wireless device may transmit another type of control response frame, different from a CTS frame, in response to such an MU RTS trigger frame. For example, the receiving wireless device may transmit an enhanced CTS (eCTS) frame that includes added control information (such as A-control information). In the implementation of an MU RTS trigger frame, the location of the temporary primary channel may be directly indicated in the RU allocation field of the User Info field itself.

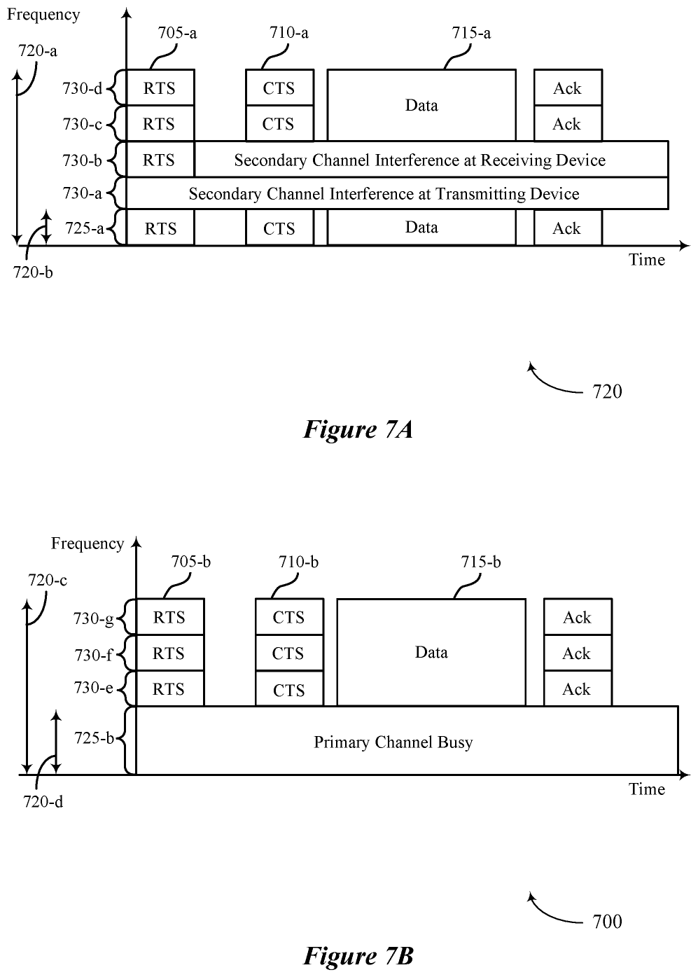

FIGS. 7A and 7B show an example of a signaling diagram 700 and a signaling diagram 720 that support enhancements to RTS and CTS exchanges. The signaling diagram 700 and the signaling diagram 720 may implement aspects of the wireless communication network 100, the PDU 200, the PDU 350, and the PPDU 400. For example, the signaling diagram 700 and the signaling diagram 720 may include an RTS frame 705 and a CTS frame 710, which may be examples of frames to be included in a PSDU 404 of a PPDU 400, as described with reference to FIG. 4.

In FIG. 7A, a transmitting wireless device may indicate a bandwidth extension to a receiving device via an RTS frame 705-a. A beacon frame (such as the beacon frame 550 as described with reference to FIG. 5) may indicate a channel bandwidth 720-b for communication between the transmitting device and the receiving device. For example, the beacon frame may indicate one or more primary channels 725-a, and the primary channel may occupy the channel bandwidth 720-b (such as 20 MHz). The RTS frame may indicate an expansion of the bandwidth for wireless communication with the receiving device from the channel bandwidth 720-b to the channel bandwidth 720-a (such as 320 MHz), which may be larger than the channel bandwidth 720-b.

In some examples, wireless devices may use dynamic puncturing of RTS or CTS frames, as described in greater detail with reference to FIG. 6, to support interference avoidance. There may be secondary channel interference at a transmitting wireless device at a secondary channel 730-a of a channel bandwidth that is associated with the RTS frame 705-a. As such, the transmitting wireless device may indicate, in the RTS frame 705-a, that one or more secondary channels are unavailable via a first puncturing pattern. The first puncturing pattern may indicate that a first subset of channels of a set of channels within the channel bandwidth 720-a are available at the transmitting device and that the secondary channel 730-a is punctured. The first subset of channels may include the primary channel 725-a, a secondary channel 730-b, a secondary channel 730-c, and a secondary channel 730-d.

At the receiving wireless device, there may be secondary channel interference at a secondary channel 730-b of the channel bandwidth 720-a. The receiving wireless device may indicate, via the CTS frame 710-a, a second puncturing pattern that is different from the first puncturing pattern, and the second puncturing pattern may indicate that a second subset of channels of the set of channels within the channel bandwidth 720-a are available at the receiving wireless device and that the secondary channel 730-a and the secondary channel 730-b are punctured. The second subset of channels may include the primary channel 725-a, the secondary channel 730-c, and the secondary channel 730-d. The second subset of channels may be a subset of the first subset of channels. Based on the CTS frame 710-a, the transmitting wireless device may transmit data 715-a to the receiving wireless device via the second subset of channels. The transmitting wireless device may transmit the data 715-a over non-contiguous channels within the channel bandwidth 720-a. For example, the transmitting wireless device may transmit the data 715-a over the primary channel 725-a, the secondary channel 730-c, and the secondary channel 730-d, skipping the secondary channel 730-a and the secondary channel 730-b. In some examples, the receiving wireless device may be in a primary channel listening mode (such as 20 MHz listening mode). In such examples, the transmitting device may transmit the RTS frame 705 via at least the primary channel 725-a such that the receiving device is able to read the RTS frame 705-a.

In FIG. 7B, a transmitting wireless device may indicate a bandwidth extension to a receiving device via an RTS frame 705-b. A beacon frame (such as the beacon frame 550 as described with reference to FIG. 5) may indicate a channel bandwidth 720-d for communication between the transmitting device and the receiving device. For example, the beacon frame may indicate one or more primary channels 725-b, and the primary channel may occupy the channel bandwidth 720-d (for example, 80 MHz). The RTS frame may indicate an expansion of the bandwidth for wireless communication with the receiving device from the channel bandwidth 720-d to the channel bandwidth 720-c (such as 320 MHz), which may be larger than the channel bandwidth 720-d.

The primary channel 725-b may be busy. For example, the primary channel 725-b may be unavailable at the transmitting wireless device. The transmitting wireless device may indicate, via the RTS frame 705-b, that the primary channel 725-b is unavailable via a first puncturing pattern or via an indication of a temporary primary channel. In some examples, the RTS frame 705-b may designate a secondary channel 730-e as the temporary primary channel of communication between the transmitting wireless device and the receiving wireless device. The first puncturing pattern may indicate that a first subset of channels of a set of channels within the channel bandwidth 720-c are available at the transmitting device and that the primary channel 725-b is punctured. The first subset of channels may include the secondary channel 730-e, a secondary channel 730-f, and a secondary channel 730-g. The receiving wireless device may receive the RTS frame 705-b and may confirm the puncturing pattern (such as may indicate a second puncturing pattern that is the same as the puncturing pattern) via a CTS frame 710-b. For example, the second puncturing pattern may indicate that a second subset of channels of a set of channels within the channel bandwidth 720-c are available at the receiving device and that the primary channel 725-b is punctured. The second subset of channels may include the secondary channel 730-e, the secondary channel 730-f, and the secondary channel 730-g. As such, the first subset of channels and the second subset of channels may be the same. Based on the CTS frame 710-b, the transmitting wireless device may transmit data 715-b to the receiving wireless device via the second subset of channels.

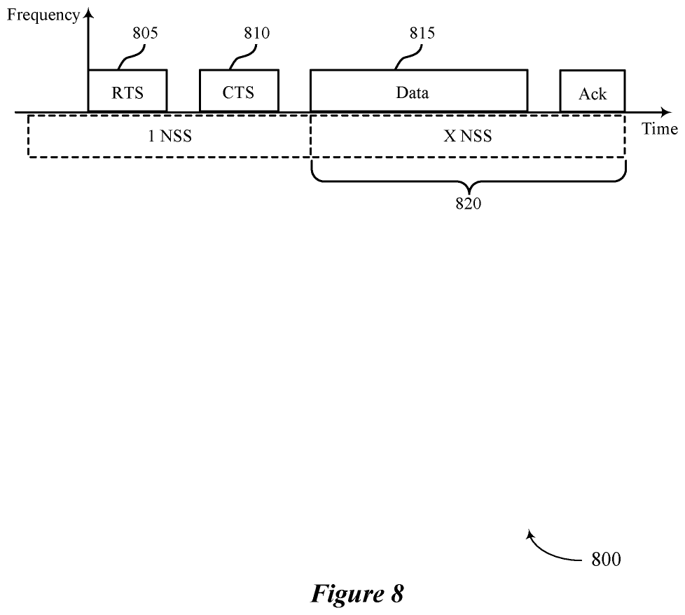

FIG. 8 shows an example of a signaling diagram 800 that supports enhancements to RTS and CTS exchanges. The signaling diagram 800 may implement aspects of the wireless communication network 100, the PDU 200, the PDU 350, and the PPDU 400. For example, the signaling diagram 800 may include an RTS frame 805, a CTS frame 810, which may be examples of frames to be included in a PSDU 404 of a PPDU 400, as described with reference to FIG. 4.

In some examples, a receiving wireless device may update an NSS for performing wireless communication via the RTS/CTS exchange. Updating the NSS may be beneficial to reduce power consumption, to reduce NSS during periods of low throughput, to provide in-device coexistence, to support antennae sharing with other devices (such as Bluetooth devices, LTE devices), to enable dynamic resource management, and to shift resources from one link to another in periods of inactivity (such as enhanced multi-link single radio (eMLSR) operations, enhanced multi-link multiple radio (eMLMR) operations, link enable/disable), among other benefits. In some examples, an STA may dynamically adapt an Rx NSS by sending an operating mode notification (OMN) frame, or an MPDU containing an operating mode control field. Changes to the NSS may take effect after the TXOP during which the OMN or the MPDU occurred. Changes to the NSS may be based on a pre-emptive involvement of the receiving wireless device in updating the NSS. For example, the receiving wireless device may notify the transmitting wireless device of an NSS change within a time threshold.

In some examples, events that may trigger an NSS switch at the receiving device may not be predictable. A receiving STA may determine to update the NSS, but the update to the NSS may be too late to provide any benefit. The receiving STA may be unable to notify a transmitting device (such as a peer STA or an AP) of the update to the NSS, for example, due to a channel being busy, due to EDCA being disabled, or due to an unavailability of the transmitting device. Such events that trigger an NSS switch may be frequent (such as antennae sharing across multiple links or across multiple technologies). A failure of the receiving device to efficiently switch the NSS may cause the receiving device to advertise conservative NSS values, which may result in underutilization of resources, or may cause the receiving device to fail to receive communications that are associated with a higher than supported NSS, which may result in data loss. Thus, the failure of the receiving device to efficiently switch the NSS may cause reduced throughput, increased delay, and increased power consumption for the receiving device.

In some examples, to support efficient update of the NSS at the receiving device, a transmitting wireless device and a receiving wireless device may exchange an RTS frame 805 and a CTS frame 810, and the RTS frame 805 or the CTS frame 810 may update an NSS that the receiving wireless device uses to communicate with the transmitting wireless device. The transmitting wireless device and the receiving wireless device may indicate the NSS using a subset of reserved SERVICE bits of a service field (such as the service field 605, as described with reference to FIG. 6). For example, the transmitting wireless device or the receiving wireless device may use bits B11-B14 of the service field for indication of the NSS to be used at the receiving device (such as during a TXOP 820). The wireless devices may use the service field for indication of the NSS at the receiving device in 6 GHz wireless networks. Additionally, or alternatively, additional control fields may be added to the RTS frame 805 or the CTS frame 810, as described in greater detail with reference to FIG. 9, to indicate the NSS at the receiving device.

Prior to receiving the RTS frame 805 (such as in a default mode), the receiving device may use a first NSS (such as one NSS) to listen to the channel (such as to monitor the primary channel for the RTS frame 805). The transmitting wireless device may indicate, via the RTS frame 805, a second NSS, which may be the same as or different than the first NSS, that the transmitting wireless device requests the receiving wireless device to use during the TXOP 820. The receiving wireless device may either confirm the requested NSS or may indicate an available NSS for the TXOP 820. That is, the receiving wireless device may indicate that a third NSS (such as X NSS, where X is a positive integer) are available, and the third NSS may be the same as the second NSS (such as to confirm the second NSS) or may be different from the second NSS.

After transmission of the CTS frame 810, the receiving wireless device may switch from the first NSS to the third NSS. The receiving wireless device may remain in a mode associated with the third NSS until expiration of the TXOP 820. The receiving wireless device may receive data 815 via the third NSS. By supporting dynamic indication of the NSS via the RTS frame 805 and the CTS frame 810, the transmitting wireless device and the receiving wireless device may support reduced power consumption, coexistence, and increased throughput.

FIGS. 9A and 9B show an example of an RTS frame 915 and a CTS frame 900 that supports enhancements to RTS and CTS exchanges. The RTS frame 915 and the CTS frame 900 may implement aspects of the wireless communication network 100, the PDU 200, the PDU 350, the PPDU 400, and the signaling diagram 500. For example, the RTS frame 915 and the CTS frame 900 may be examples of an RTS frame 505 and a CTS frame 510, respectively, as described with reference to FIG. 5.

In some examples, an RTS frame may have a length of 20 octets and a CTS frame may have a length of 14 octets. A receiving wireless device may obtain the length of the RTS frame via an L-SIG field of a PPDU or via another field of the PPDU. In some examples, it may be beneficial to expand the length of the RTS frame or the CTS frame such that the RTS frame or the CTS frame includes additional control information. A transmitting wireless device that transmits the RTS frame 915 or a receiving wireless device that transmits the CTS frame 900 may use the additional control information to perform bandwidth extension or dynamic puncturing, as described with reference to FIG. 6, dynamic indication of NSS, as described with reference to FIG. 8, link adaptation signaling, or indication of interference statistics, among other procedures.

FIG. 9A may show an RTS frame 915 with a format that supports the inclusion of additional control information to the RTS frame 915. The RTS frame 915 may include a control information field 905-a that includes the additional control information. In some examples, the control information field 905-a may be an A-control field. The control information field 905-a may occur prior to the FCS field and after the transmitter address (TA) field.

FIG. 9B may show a CTS frame 900 with a format that supports the inclusion of additional control information to the CTS frame 900. The CTS frame 900 may include a control information field 905-b that includes the additional control information. In some examples, the control information field 905-b may be an A-control field. The control information field 905-b may occur prior to the FCS field and after the transmitter address (TA) field.

A length field (such as an L-Length field) of the PPDU may indicate a length of the RTS or CTS frame and a type field or a subtype field of the PPDU may identify that the frame is an RTS or CTS frame. The length field for the RTS frame 915 may indicate a length greater than 20 octets, which may indicate that the RTS frame 915 is an A-RTS frame (such as an RTS frame that includes an A-control field), and the length field for the CTS frame 900 may indicate a length greater than 14 octets, which may indicate that the CTS frame 900 is an A-CTS frame (such as a CTS frame that includes an A-control field).

In some examples, an RTS frame or a CTS frame may be sent within a control wrapper frame that includes the additional control information. For example, a control wrapper frame may include the RTS frame or the CTS frame and control information (such as an HT control field) that includes the additional control information. The RTS control wrapper frame or the CTS control wrapper frame may take a place of the RTS frame or the CTS frame in a RTS/CTS exchange between wireless devices. In some other examples, control frames other than the RTS frame or the CTS frame may be exchanged to communicate the additional control information between a transmitting wireless device and a receiving wireless device (such as an MU RTS trigger variant or a different subtype of control frames, among other examples).

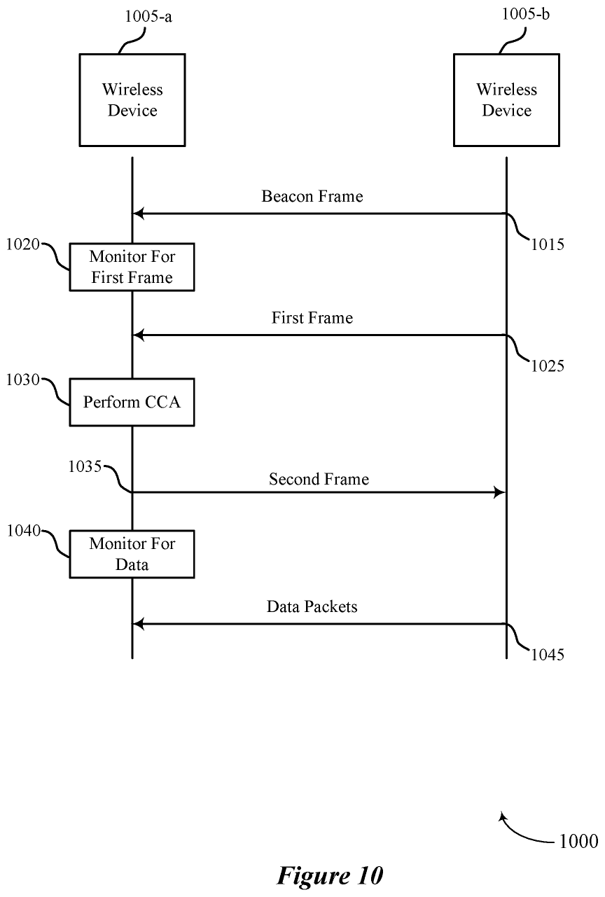

FIG. 10 shows an example of a process flow 1000 that supports enhancements to RTS and CTS exchanges. The process flow 1000 may implement aspects of the wireless communication network 100, the PDU 200, the PDU 350, and the PPDU 400. For example, the process flow 1000 may include a wireless device 1005-a and a wireless device 1005-b, which may be examples of an STA 104 or an AP 102, as described with reference to FIG. 1. In the following description of the process flow 1000, the operations between the wireless device 1005-a and the wireless device 1005-b may be transmitted in a different order than the example order shown, or the operations performed by the wireless device 1005-a and the wireless device 1005-b may be performed in different orders or at different times. Some operations also may be omitted from the process flow 1000, and other operations may be added to the process flow 1000.

At 1015, the wireless device 1005-a may receive a beacon frame indicating for the first wireless device to monitor a first channel for a first frame (such as an RTS frame) that schedules communication via one or more channels. The first channel may be a primary channel (such as a 20 MHz primary channel) of communication between the wireless device 1005-a and the wireless device 1005-b. The first frame may schedule transmission of one or more data packets to the wireless device 1005-b. At 1020, the wireless device 1005-a may monitor the first channel for the first frame based on the beacon frame.

At 1025, the wireless device 1005-a may receive, from the wireless device 1005-b, the first frame indicating a channel bandwidth (such as indicating to expand a channel bandwidth for communication, as described with reference to FIGS. 7A and 7B) and indicating a puncturing pattern of multiple available puncturing patterns for the channel bandwidth. The puncturing pattern may be associated with a first subset of a set of multiple channels of the channel bandwidth. For example, the puncturing pattern may indicate that secondary channels of the channel bandwidth are busy. In implementations of non-primary channel access, the wireless device 1005-a may receive the RTS frame via a secondary channel, or the puncturing pattern may indicate the location of a temporary primary channel, or both. In some examples, the first frame may request a NSS for the wireless device 1005-a to use during the TXOP.

At 1030, the wireless device 1005-a may perform a CCA of each channel of the first subset of the set of multiple channels indicated in the first frame. For example, the wireless device 1005-a may perform the CCA during a SIFS that occurs between reception of the first frame and transmission of the at least one second frame. Based on the CCA, the wireless device 1005-a may determine that a subset of the first subset of the set of multiple channels are available at the wireless device 1005-a.

At 1035, the wireless device 1005-a may transmit, to the wireless device 1005-b, at least one second frame indicating that a second subset of the set of multiple channels is available. The second subset may be at least a subset of the first subset. In some examples, the second frame may indicate a second puncturing pattern that may confirm the puncturing pattern indicated in the first frame or may indicate a puncturing pattern that is different from that indicated in the first frame. In some examples, the second frame may indicate a second NSS that may confirm the NSS indicated in the first frame or may indicate a NSS that is different from that indicated in the first frame. At 1040, the wireless device 1005-a may monitor the second subset of the set of multiple channels for one or more data packets based on the at least one second frame.

At 1045, the wireless device 1005-a may receive, from the wireless device 1005-b, one or more data packets via the second subset of the set of multiple channels based on the at least one second frame. In some examples, the wireless device 1005-a may indicate receipt of the one or more data packets via a feedback message (e.g., an ACK message or a negative ACK message) that the wireless device 1005-a transmits to the wireless device 1005-b.

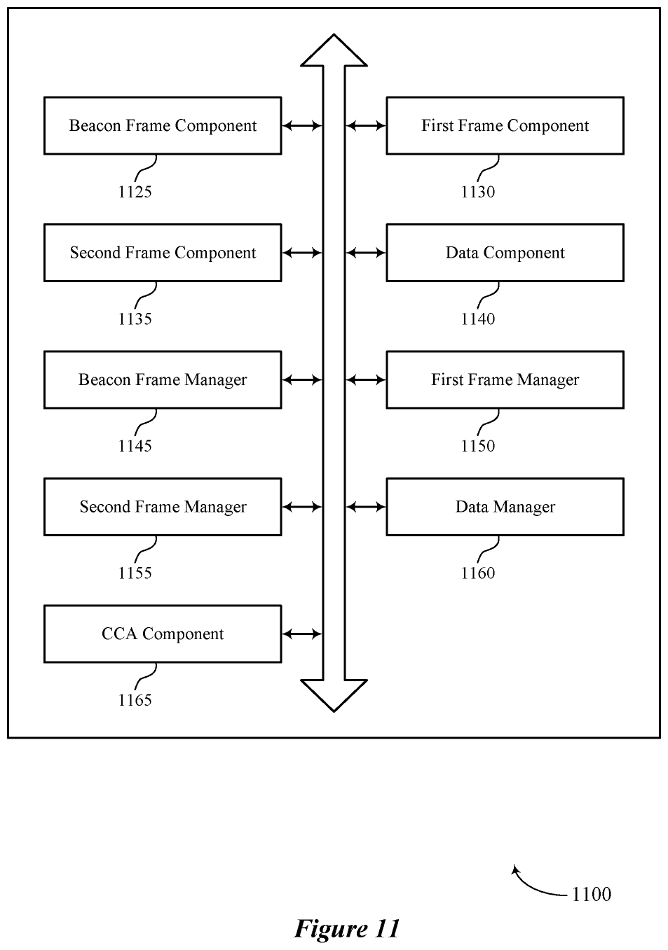

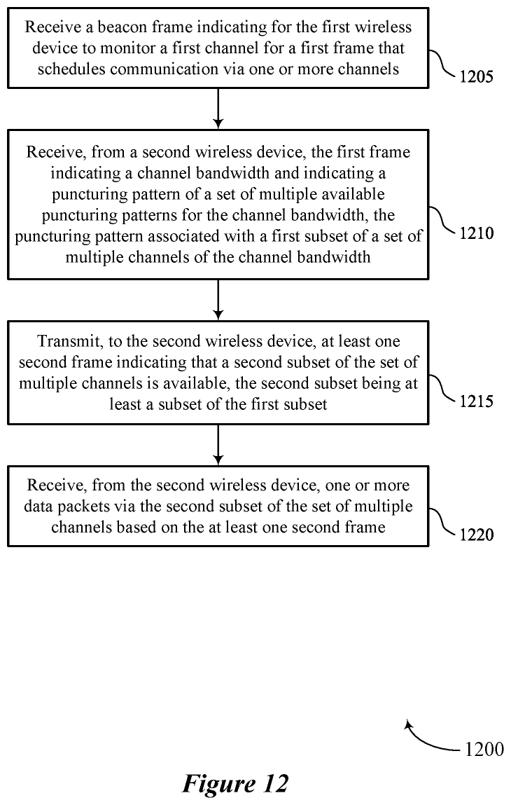

FIG. 11 shows a block diagram of an example wireless communication device 1100 that supports enhancements to RTS and CTS exchanges. In some examples, the wireless communication device 1100 is configured to perform the processes 1200, 1300, and 1400 described with reference to FIGS. 12, 13, and 14, respectively. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can configurable or configured for use in an AP or STA, such as the AP 102 or the STA 104 described with reference to FIG. 1. In some other examples, the wireless communication device 1100 can be an AP or STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a beacon frame component 1125, a first frame component 1130, a second frame component 1135, a data component 1140, a beacon frame manager 1145, a first frame manager 1150, a second frame manager 1155, a data manager 1160, and a CCA component 1165. Portions of one or more of the beacon frame component 1125, the first frame component 1130, the second frame component 1135, the data component 1140, the beacon frame manager 1145, the first frame manager 1150, the second frame manager 1155, the data manager 1160, and the CCA component 1165 may be implemented at least in part in hardware or firmware. For example, one or more of the beacon frame component 1125, the first frame component 1130, the second frame component 1135, the data component 1140, the beacon frame manager 1145, the first frame manager 1150, the second frame manager 1155, the data manager 1160, and the CCA component 1165 may be implemented at least in part by at least a processor or a modem. In some examples, portions of one or more of the beacon frame component 1125, the first frame component 1130, the second frame component 1135, the data component 1140, the beacon frame manager 1145, the first frame manager 1150, the second frame manager 1155, the data manager 1160, and the CCA component 1165 may be implemented at least in part by a processor and software in the form of processor-executable code stored in memory.

The wireless communication device 1100 may support wireless communications in accordance with examples as disclosed herein. The beacon frame component 1125 is configurable or configured to receive a beacon frame indicating for the first wireless device to monitor a first channel for a first frame that schedules communication via one or more channels. The first frame component 1130 is configurable or configured to receive, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth. The second frame component 1135 is configurable or configured to transmit, to the second wireless device, at least one second frame indicating that a second subset of the set of multiple channels is available, the second subset being at least a subset of the first subset. The data component 1140 is configurable or configured to receive, from the second wireless device, one or more data packets via the second subset of the set of multiple channels based on the at least one second frame.

In some examples, the first channel be associated with a second channel bandwidth that is smaller than the channel bandwidth.

In some examples, the first frame component 1130 is configurable or configured to monitor the first channel for the first frame based on the beacon frame. In some examples, the data component 1140 is configurable or configured to monitor the second subset of the set of multiple channels for the one or more data packets based on the at least one second frame.

In some examples, the beacon frame indicate a second channel within the channel bandwidth to monitor for the first frame.

In some examples, the first channel be a primary channel of communication with the second wireless device and the second channel is a secondary channel of communication with the second wireless device.

In some examples, the first frame indicate a first NSS associated with wireless communication with the second wireless device.

In some examples, the at least one second frame indicate that a second NSS are available. In some examples, the one or more data packets be received via the second NSS.

In some examples, the second NSS be the same as the first NSS or is different from the first NSS.

In some examples, at least one of the first frame or the at least one second frame include an A-control field including control information.

In some examples, the first frame indicate a first duration associated with a wireless communication session with the second wireless device. In some examples, the at least one second frame indicate a second duration different from the first duration.

In some examples, the at least one second frame include an indication that the first wireless device is available for wireless communication via the first subset of the set of multiple channels.

In some examples, the at least one second frame be transmitted after expiration of a time duration, the time duration beginning after receipt of the first frame and associated with a NAV of the channel bandwidth.

In some examples, the puncture pattern indicates that the first channel is punctured.

In some examples, the CCA component 1165 is configurable or configured to perform a CCA of each channel of the set of multiple channels based on the first frame, where the second subset of the set of multiple channels is based on the CCA.

In some examples, the CCA may be performed during a short interframe space that occurs between reception of the first frame and transmission of the at least one second frame.

In some examples, the first wireless device be a first wireless STA or a first AP and the second wireless device is a second wireless STA or a second AP.

Additionally, or alternatively, the wireless communication device 1100 may support wireless communications in accordance with examples as disclosed herein. The beacon frame manager 1145 is configurable or configured to transmit a beacon frame indicating for a second wireless device to monitor a first channel for a first frame that schedules communication via one or more channels. The first frame manager 1150 is configurable or configured to transmit, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth. The second frame manager 1155 is configurable or configured to receive, from the second wireless device, at least one second frame indicating that a second subset of the set of multiple channels is available, the second subset being at least a subset of the first subset. The data manager 1160 is configurable or configured to transmit, to the second wireless device, one or more data packets via the second subset of the set of multiple channels based on the at least one second frame.

In some examples, the first channel be associated with a second channel bandwidth that is smaller than the channel bandwidth.

In some examples, the beacon frame indicate a second channel within the channel bandwidth to monitor for the first frame.

In some examples, the first channel be a primary channel of communication with the second wireless device and the second channel is a secondary channel of communication with the second wireless device.

In some examples, the first frame indicate a first NSS associated with wireless communication with the second wireless device.

In some examples, the at least one second frame indicate that a second NSS are available. In some examples, the one or more data packets be transmitted via the second NSS.

In some examples, the second NSS be the same as the first NSS or is different from the first NSS.

In some examples, at least one of the first frame or the at least one second frame include an A-control field including control information.

In some examples, the first frame indicate a first duration associated with a wireless communication session with the second wireless device. In some examples, the at least one second frame indicate a second duration different from the first duration.

In some examples, the at least one second frame include an indication that the second wireless device is available for wireless communication via the first subset of the set of multiple channels.

In some examples, the at least one second frame be received after expiration of a time duration, the time duration beginning after transmission of the first frame and associated with a NAV of the channel bandwidth.

In some examples, the puncture pattern indicates that the first channel is punctured.

In some examples, the first wireless device be a first wireless STA or a first AP and the second wireless device is a second wireless STA or a second AP.

FIG. 12 shows a flowchart illustrating an example process 1200 performable by or at a first wireless device that supports enhancements to RTS and CTS exchanges. The operations of the process 1200 may be implemented by a first wireless device or its components as described herein. For example, the process 1200 may be performed by a wireless communication device, such as the wireless communication device 1100 described with reference to FIG. 11, operating as or within a wireless AP or a wireless STA. In some examples, the process 1200 may be performed by a wireless AP or a wireless STA, such as one of the APs 102 or the STAs 104 described with reference to FIG. 1.

In some examples, in block 1205, the first wireless device may receive a beacon frame indicating for the first wireless device to monitor a first channel for a first frame that schedules communication via one or more channels. The operations of block 1205 may be performed in accordance with examples as disclosed herein. In some implementations, aspects of the operations of block 1205 may be performed by a beacon frame component 1125 as described with reference to FIG. 11.

In some examples, in block 1210, the first wireless device may receive, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth. The operations of block 1210 may be performed in accordance with examples as disclosed herein. In some implementations, aspects of the operations of block 1210 may be performed by a first frame component 1130 as described with reference to FIG. 11.

In some examples, in block 1215, the first wireless device may transmit, to the second wireless device, at least one second frame indicating that a second subset of the set of multiple channels is available, the second subset being at least a subset of the first subset. The operations of block 1215 may be performed in accordance with examples as disclosed herein. In some implementations, aspects of the operations of block 1215 may be performed by a second frame component 1135 as described with reference to FIG. 11.

In some examples, in block 1220, the first wireless device may receive, from the second wireless device, one or more data packets via the second subset of the set of multiple channels based on the at least one second frame. The operations of block 1220 may be performed in accordance with examples as disclosed herein. In some implementations, aspects of the operations of block 1220 may be performed by a data component 1140 as described with reference to FIG. 11.

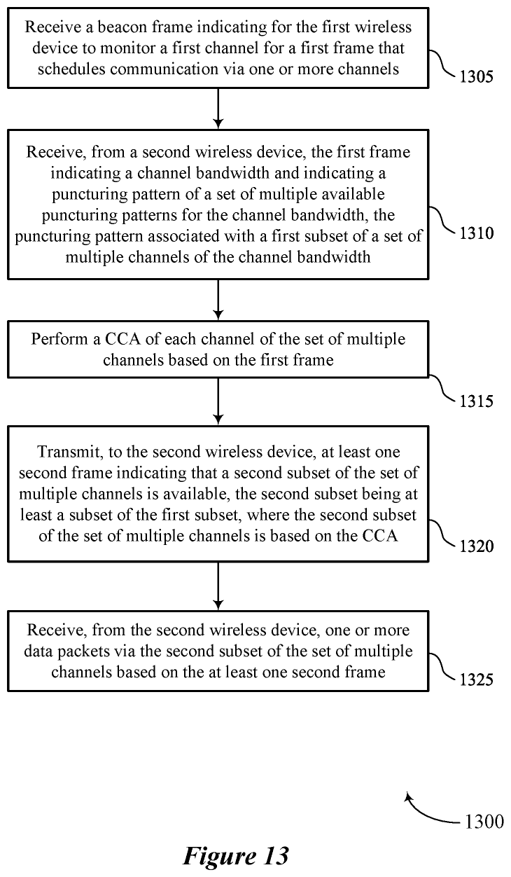

FIG. 13 shows a flowchart illustrating an example process 1300 performable by or at a first wireless device that supports enhancements to RTS and CTS exchanges. The operations of the process 1300 may be implemented by a first wireless device or its components as described herein. For example, the process 1300 may be performed by a wireless communication device, such as the wireless communication device 1100 described with reference to FIG. 11, operating as or within a wireless AP or a wireless STA. In some examples, the process 1300 may be performed by a wireless AP or a wireless STA, such as one of the APs 102 or the STAs 104 described with reference to FIG. 1.

In some examples, in block 1305, the first wireless device may receive a beacon frame indicating for the first wireless device to monitor a first channel for a first frame that schedules communication via one or more channels. The operations of block 1305 may be performed in accordance with examples as disclosed herein. In some implementations, aspects of the operations of block 1305 may be performed by a beacon frame component 1125 as described with reference to FIG. 11.

In some examples, in block 1310, the first wireless device may receive, from a second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth. The operations of block 1310 may be performed in accordance with examples as disclosed herein. In some implementations, aspects of the operations of block 1310 may be performed by a first frame component 1130 as described with reference to FIG. 11.

In some examples, in block 1315, the first wireless device may perform a CCA of each channel of the set of multiple channels based on the first frame. The operations of block 1315 may be performed in accordance with examples as disclosed herein. In some implementations, aspects of the operations of block 1315 may be performed by a CCA component 1165 as described with reference to FIG. 11.

In some examples, in block 1320, the first wireless device may transmit, to the second wireless device, at least one second frame indicating that a second subset of the set of multiple channels is available, the second subset being at least a subset of the first subset, where the second subset of the set of multiple channels is based on the CCA. The operations of block 1320 may be performed in accordance with examples as disclosed herein. In some implementations, aspects of the operations of block 1320 may be performed by a second frame component 1135 as described with reference to FIG. 11.

In some examples, in block 1325, the first wireless device may receive, from the second wireless device, one or more data packets via the second subset of the set of multiple channels based on the at least one second frame. The operations of block 1325 may be performed in accordance with examples as disclosed herein. In some implementations, aspects of the operations of block 1325 may be performed by a data component 1140 as described with reference to FIG. 11.

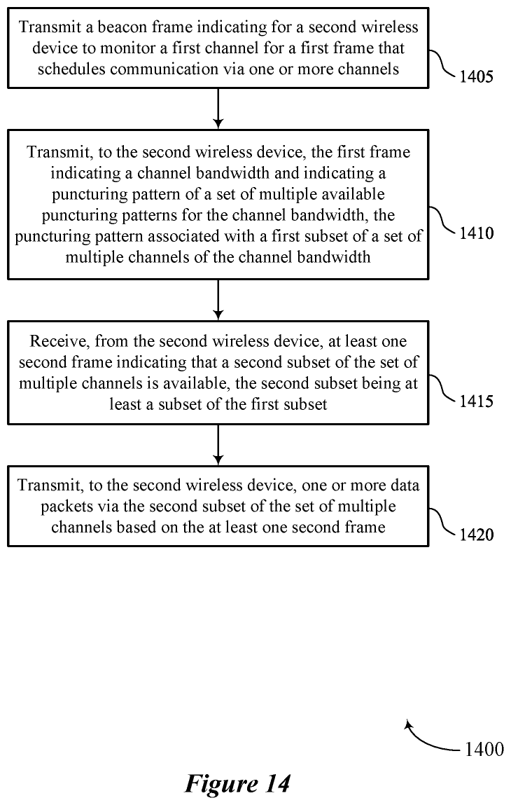

FIG. 14 shows a flowchart illustrating an example process 1400 performable by or at a first wireless device that supports enhancements to RTS and CTS exchanges. The operations of the process 1400 may be implemented by a first wireless device or its components as described herein. For example, the process 1400 may be performed by a wireless communication device, such as the wireless communication device 1100 described with reference to FIG. 11, operating as or within a wireless AP or a wireless STA. In some examples, the process 1400 may be performed by a wireless AP or a wireless STA, such as one of the APs 102 or the STAs 104 described with reference to FIG. 1.

In some examples, in block 1405, the first wireless device may transmit a beacon frame indicating for a second wireless device to monitor a first channel for a first frame that schedules communication via one or more channels. The operations of block 1405 may be performed in accordance with examples as disclosed herein. In some implementations, aspects of the operations of block 1405 may be performed by a beacon frame manager 1145 as described with reference to FIG. 11.

In some examples, in block 1410, the first wireless device may transmit, to the second wireless device, the first frame indicating a channel bandwidth and indicating a puncturing pattern of a set of multiple available puncturing patterns for the channel bandwidth, the puncturing pattern associated with a first subset of a set of multiple channels of the channel bandwidth. The operations of block 1410 may be performed in accordance with examples as disclosed herein. In some implementations, aspects of the operations of block 1410 may be performed by a first frame manager 1150 as described with reference to FIG. 11.

In some examples, in block 1415, the first wireless device may receive, from the second wireless device, at least one second frame indicating that a second subset of the set of multiple channels is available, the second subset being at least a subset of the first subset. The operations of block 1415 may be performed in accordance with examples as disclosed herein. In some implementations, aspects of the operations of block 1415 may be performed by a second frame manager 1155 as described with reference to FIG. 11.

In some examples, in block 1420, the first wireless device may transmit, to the second wireless device, one or more data packets via the second subset of the set of multiple channels based on the at least one second frame. The operations of block 1420 may be performed in accordance with examples as disclosed herein. In some implementations, aspects of the operations of block 1420 may be performed by a data manager 1160 as described with reference to FIG. 11.

Implementation examples are described in the following numbered clauses:

The following provides an overview of aspects of the present disclosure:
Aspect 1: A method for wireless communications by a first wireless device, comprising: receiving a beacon frame indicating for the first wireless device to monitor a first channel for a first frame that schedules communication via one or more channels; receiving, from a second wireless device, the first frame indicating a channel bandwidth and indicating a puncturing pattern of a plurality of available puncturing patterns for the channel bandwidth, the puncturing pattern associated with a first subset of a plurality of channels of the channel bandwidth; transmitting, to the second wireless device, at least one second frame indicating that a second subset of the plurality of channels is available, the second subset being at least a subset of the first subset; and receiving, from the second wireless device, one or more data packets via the second subset of the plurality of channels based at least in part on the at least one second frame.
Aspect 2: The method of aspect 1, wherein the first channel is associated with a second channel bandwidth that is smaller than the channel bandwidth.
Aspect 3: The method of any of aspects 1-2, further comprising: monitoring the first channel for the first frame based at least in part on the beacon frame; and monitoring the second subset of the plurality of channels for the one or more data packets based at least in part on the at least one second frame.
Aspect 4: The method of any of aspects 1-3, wherein the beacon frame indicates a second channel within the channel bandwidth to monitor for the first frame.
Aspect 5: The method of aspect 4, wherein the first channel is a primary channel of communication with the second wireless device and the second channel is a secondary channel of communication with the second wireless device.
Aspect 6: The method of any of aspects 1-5, wherein the first frame indicates a first NSS associated with wireless communication with the second wireless device.
Aspect 7: The method of aspect 6, wherein the at least one second frame indicates that a second NSS are available, and the one or more data packets are received via the second NSS
Aspect 8: The method of aspect 7, wherein the second NSS is the same as the first NSS or is different from the first NSS.
Aspect 9: The method of any of aspects 1-8, wherein at least one of the first frame or the at least one second frame includes an A-control field comprising control information.
Aspect 10: The method of any of aspects 1-9, wherein the first frame indicates a first duration associated with a wireless communication session with the second wireless device, and the at least one second frame indicates a second duration different from the first duration
Aspect 11: The method of any of aspects 1-10, wherein the at least one second frame comprises an indication that the first wireless device is available for wireless communication via the first subset of the plurality of channels.
Aspect 12: The method of any of aspects 1-11, wherein the at least one second frame is transmitted after expiration of a time duration, the time duration beginning after receipt of the first frame and associated with a NAV of the channel bandwidth.
Aspect 13: The method of any of aspects 1-12, wherein the puncturing pattern indicates that the first channel is punctured.
Aspect 14: The method of any of aspects 1-13, further comprising: performing a CCA of each channel of the plurality of channels based at least in part on the first frame, wherein the second subset of the plurality of channels is based at least in part on the CCA.
Aspect 15: The method of aspect 14, wherein the CCA is performed during a SIFS that occurs between reception of the first frame and transmission of the at least one second frame.
Aspect 16: The method of any of aspects 1-15, wherein the first wireless device is a first wireless STA or a first AP and the second wireless device is a second wireless STA or a second AP.
Aspect 17: A method for wireless communications by a first wireless device, comprising: transmitting a beacon frame indicating for a second wireless device to monitor a first channel for a first frame that schedules communication via one or more channels; transmitting, to the second wireless device, the first frame indicating a channel bandwidth and indicating a puncturing pattern of a plurality of available puncturing patterns for the channel bandwidth, the puncturing pattern associated with a first subset of a plurality of channels of the channel bandwidth; receiving, from the second wireless device, at least one second frame indicating that a second subset of the plurality of channels is available, the second subset being at least a subset of the first subset; and transmitting, to the second wireless device, one or more data packets via the second subset of the plurality of channels based at least in part on the at least one second frame.
Aspect 18: The method of aspect 17, wherein the first channel is associated with a second channel bandwidth that is smaller than the channel bandwidth.
Aspect 19: The method of aspect 18, wherein the beacon frame indicates a second channel within the channel bandwidth to monitor for the first frame.
Aspect 20: The method of aspect 19, wherein the first channel is a primary channel of communication with the second wireless device and the second channel is a secondary channel of communication with the second wireless device.
Aspect 21: The method of any of aspects 17-20, wherein the first frame indicates a first NSS associated with wireless communication with the second wireless device.
Aspect 22: The method of aspect 21, wherein the at least one second frame indicates that a second NSS are available, and the one or more data packets are transmitted via the second NSS
Aspect 23: The method of aspect 22, wherein the second NSS is the same as the first NSS or is different from the first NSS.
Aspect 24: The method of any of aspects 17-23, wherein at least one of the first frame or the at least one second frame includes an A-control field comprising control information.
Aspect 25: The method of any of aspects 17-24, wherein the first frame indicates a first duration associated with a wireless communication session with the second wireless device, and the at least one second frame indicates a second duration different from the first duration
Aspect 26: The method of any of aspects 17-25, wherein the at least one second frame comprises an indication that the second wireless device is available for wireless communication via the first subset of the plurality of channels.
Aspect 27: The method of any of aspects 17-26, wherein the at least one second frame is received after expiration of a time duration, the time duration beginning after transmission of the first frame and associated with a NAV of the channel bandwidth.
Aspect 28: The method of any of aspects 17-27, wherein the puncturing pattern indicates that the first channel is punctured.
Aspect 29: The method of any of aspects 17-28, wherein the first wireless device is a first wireless STA or a first AP and the second wireless device is a second wireless STA or a second AP.
Aspect 30: A first wireless device comprising a processing system that includes processor circuitry and memory circuitry that stores code, the processing system configured to cause the first wireless device to perform a method of any of aspects 1-16.
Aspect 31: A first wireless device comprising at least one means for performing a method of any of aspects 1-16.
Aspect 32: A non-transitory computer-readable medium storing code, the code comprising instructions executable by one or more processors to perform a method of any of aspects 1-16.
Aspect 33: A first wireless device comprising a processing system that includes processor circuitry and memory circuitry that stores code, the processing system configured to cause the first wireless device to perform a method of any of aspects 17-29.
Aspect 34: A first wireless device comprising at least one means for performing a method of any of aspects 17-29.
Aspect 35: A non-transitory computer-readable medium storing code, the code comprising instructions executable by one or more processors to perform a method of any of aspects 17-29.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
receive a beacon frame indicating for the first wireless device to monitor a first channel for a first frame that schedules communication via one or more channels;
receive, from a second wireless device, the first frame indicating a channel bandwidth and indicating a puncturing pattern of a plurality of available puncturing patterns for the channel bandwidth, the puncturing pattern associated with a first subset of a plurality of channels of the channel bandwidth;
transmit, to the second wireless device, at least one second frame indicating that a second subset of the plurality of channels is available, the second subset being at least a subset of the first subset; and
receive, from the second wireless device, one or more data packets via the second subset of the plurality of channels based at least in part on the at least one second frame.

2. The first wireless device of claim 1, wherein the first channel is associated with a second channel bandwidth that is smaller than the channel bandwidth.

3. The first wireless device of claim 1, wherein the processing system is further configured to cause the first wireless device to:
monitor the first channel for the first frame based at least in part on the beacon frame; and
monitor the second subset of the plurality of channels for the one or more data packets based at least in part on the at least one second frame.

4. The first wireless device of claim 1, wherein the beacon frame indicates a second channel within the channel bandwidth to monitor for the first frame.

5. The first wireless device of claim 4, wherein the first channel is a primary channel of communication with the second wireless device and the second channel is a secondary channel of communication with the second wireless device.

6. The first wireless device of claim 1, wherein the first frame indicates a first number of spatial streams associated with wireless communication with the second wireless device.

7. The first wireless device of claim 6, wherein:
the at least one second frame indicates that a second number of spatial streams are available, and
the one or more data packets are received via the second number of spatial streams.

8. The first wireless device of claim 7, wherein the second number of spatial streams is the same as the first number of spatial streams or is different from the first number of spatial streams.

9. The first wireless device of claim 1, wherein at least one of the first frame or the at least one second frame includes an aggregated control field comprising control information.

10. The first wireless device of claim 1, wherein:
the first frame indicates a first duration associated with a wireless communication session with the second wireless device, and
the at least one second frame indicates a second duration different from the first duration.

11. The first wireless device of claim 1, wherein the at least one second frame comprises an indication that the first wireless device is available for wireless communication via the first subset of the plurality of channels.

12. The first wireless device of claim 1, wherein the at least one second frame is transmitted after expiration of a time duration, the time duration beginning after receipt of the first frame and associated with a network allocation vector of the channel bandwidth.

13. The first wireless device of claim 1, wherein the puncturing pattern indicates that the first channel is punctured.

14. The first wireless device of claim 1, wherein the processing system is further configured to cause the first wireless device to:
perform a clear channel assessment of each channel of the plurality of channels based at least in part on the first frame, wherein the second subset of the plurality of channels is based at least in part on the clear channel assessment.

15. The first wireless device of claim 14, wherein the clear channel assessment is performed during a short interframe space that occurs between reception of the first frame and transmission of the at least one second frame.

16. The first wireless device of claim 1, wherein the first wireless device is a first wireless station (STA) or a first access point (AP) and the second wireless device is a second wireless STA or a second AP.

17. A first wireless device, comprising:
a processing system that includes processor circuitry and memory circuitry that stores code, the processing system configured to cause the first wireless device to:
transmit a beacon frame indicating for a second wireless device to monitor a first channel for a first frame that schedules communication via one or more channels;
transmit, to the second wireless device, the first frame indicating a channel bandwidth and indicating a puncturing pattern of a plurality of available puncturing patterns for the channel bandwidth, the puncturing pattern associated with a first subset of a plurality of channels of the channel bandwidth;
receive, from the second wireless device, at least one second frame indicating that a second subset of the plurality of channels is available, the second subset being at least a subset of the first subset; and
transmit, to the second wireless device, one or more data packets via the second subset of the plurality of channels based at least in part on the at least one second frame.

18. The first wireless device of claim 17, wherein the first channel is associated with a second channel bandwidth that is smaller than the channel bandwidth.

19. The first wireless device of claim 18, wherein the beacon frame indicates a second channel within the channel bandwidth to monitor for the first frame.

20. The first wireless device of claim 19, wherein the first channel is a primary channel of communication with the second wireless device and the second channel is a secondary channel of communication with the second wireless device.

21. The first wireless device of claim 17, wherein the first frame indicates a first number of spatial streams associated with wireless communication with the second wireless device.

22. The first wireless device of claim 21, wherein:
the at least one second frame indicates that a second number of spatial streams are available, and
the one or more data packets are transmitted via the second number of spatial streams.

23. The first wireless device of claim 17, wherein at least one of the first frame or the at least one second frame includes an aggregated control field comprising control information.

24. The first wireless device of claim 17, wherein:
the first frame indicates a first duration associated with a wireless communication session with the second wireless device, and
the at least one second frame indicates a second duration different from the first duration.

25. The first wireless device of claim 17, wherein the at least one second frame comprises an indication that the second wireless device is available for wireless communication via the first subset of the plurality of channels.

26. The first wireless device of claim 17, wherein the at least one second frame is received after expiration of a time duration, the time duration beginning after transmission of the first frame and associated with a network allocation vector of the channel bandwidth.

27. The first wireless device of claim 17, wherein the puncturing pattern indicates that the first channel is punctured.

28. The first wireless device of claim 17, wherein the first wireless device is a first wireless station (STA) or a first access point (AP) and the second wireless device is a second wireless STA or a second AP.

29. A method for wireless communications by a first wireless device, comprising:
receiving a beacon frame indicating for the first wireless device to monitor a first channel for a first frame that schedules communication via one or more channels;
receiving, from a second wireless device, the first frame indicating a channel bandwidth and indicating a puncturing pattern of a plurality of available puncturing patterns for the channel bandwidth, the puncturing pattern associated with a first subset of a plurality of channels of the channel bandwidth;
transmitting, to the second wireless device, at least one second frame indicating that a second subset of the plurality of channels is available, the second subset being at least a subset of the first subset; and
receiving, from the second wireless device, one or more data packets via the second subset of the plurality of channels based at least in part on the at least one second frame.

30. A method for wireless communications by a first wireless device, comprising:
transmitting a beacon frame indicating for a second wireless device to monitor a first channel for a first frame that schedules communication via one or more channels;
transmitting, to the second wireless device, the first frame indicating a channel bandwidth and indicating a puncturing pattern of a plurality of available puncturing patterns for the channel bandwidth, the puncturing pattern associated with a first subset of a plurality of channels of the channel bandwidth;
receiving, from the second wireless device, at least one second frame indicating that a second subset of the plurality of channels is available, the second subset being at least a subset of the first subset; and
transmitting, to the second wireless device, one or more data packets via the second subset of the plurality of channels based at least in part on the at least one second frame.
